(19) United States
(12) Patent Application Publication
(10) Pub. No.: US 2013/0297500 A1
(43) Pub. Date: Nov. 7, 2013

(54) Electronic Payment Automated Reconciliation Platform

(71) Applicant: EPAR, LLC, Omaha, NE (US)

(72) Inventors: Wes Miller, Omaha, NE (US); Ryan Barry, Omaha, NE (US); Kraig Williams, Omaha, NE (US)

(73) Assignee: ePar, LLC, Omaha, NE (US)

(21) Appl. No.: 13/886,996

(22) Filed: May 3, 2013

Related U.S. Application Data
(60) Provisional application No. 61/642,011, filed on May 3, 2012.

(51) Int. Cl. G06Q 20/40

(52) U.S. Cl. CPC G06Q 20/4016
USPC 705/40; 705/39

(57) ABSTRACT

The systems, methods and apparatus relate to transparent, unified financial transactions as a means of reducing inefficiency, fraud, and mistake. More specifically, the systems, methods, and apparatus address automated reconciliation of financial transactions, the establishment of a four-way reconciliation process and a unified and transparent escrow process.

### CROSS-REFERENCE TO RELATED APPLICATION(S)

The present application claims priority to U.S. Provisional Patent Application No. 61/642,011, filed May 3, 2012 and entitled “Electronic Payment Automated Reconciliation Platform” and U.S. Provisional Patent Application No. 61/788,503, filed Mar. 15, 2013 and entitled “Electronic Payment Automated Reconciliation Platform.”

### FIELD OF THE INVENTION

The embodiments disclosed herein relate generally to electronic financial transactions. The present invention more particularly relates to a unified platform for conducting escrow-type transactions transparently.

The present invention relates to devices, systems and methods for promoting sales. More specifically, the present application relates to applications for mobile devices, such as cellular phones.

### BACKGROUND OF THE INVENTION

Electronic financial transactions have become ubiquitous in the modern world. However, traditional electronic transactions are typically initiated by a payee with very little transparency, authentication or verification of payment information provided to any other parties to the transaction, such as the payor, associated lenders or insurance companies, thus providing little protection against deceit, fraud and other errors.

The problems created by these opaque traditional electronic transactions are currently being dealt with only after they have occurred, which is in essence loss mitigation. The present invention creates a solution to prevent fraud and loss, and to provide checks and alerts to the appropriate parties before the problem occurs. The present invention further relates to the holding of funds transparently in escrow to provide insurance companies with the ability to provide insurance to mitigate buyer or seller loss, and to guarantee the payment process. The present invention thus relates to loss and fraud prevention invention rather than loss and fraud mitigation.

### SUMMARY OF THE INVENTION

One object of the present invention is to allow both the payee and the payor to produce a payment together, essentially combining an invoice and a payment into one single instrument that requires authentication and verification, thus virtually eliminating the potential for fraud and errors.

Yet another object of the present invention is to allow for complete collaboration of end-to-end payment processing between interested parties while maintaining privacy associated with sensitive data. Each task, change or update is automatically dated and time logged creating a complete audit trail.

### BRIEF DESCRIPTION OF THE DRAWINGS

The features and advantages of the invention are explained in more detail in the subsequent detailed description with reference to the embodiments illustrated in the attached drawing figures, in which like reference numerals denote like elements and in which FIGS. 1-19 illustrate some embodiments of the present invention.

FIG. 1 shows a schematic of the prior art process used in mortgage lending for real estate transactions.

FIG. 2A is a schematic of an overview of possible participants according to exemplary embodiments of the present system, method and apparatus.

FIG. 2B is a further schematic of an overview of possible participants according to exemplary embodiments of the present system, method and apparatus, showing the flow of information between the participants.

FIG. 2C is a schematic overview of the present system according to an exemplary embodiment, showing the communication between the transactors by way of an apparatus that may be used in the system.

FIG. 3 is a schematic overview of an exemplary embodiment of the system demonstrating the process of four-way reconciliation.

FIG. 4 depicts two screenshots of web portals of the system according to an exemplary embodiment.

FIG. 5 depicts a screenshot of a web portal of the system according to an exemplary embodiment.

FIG. 6 depicts another screenshot of a web portal of the system according to an exemplary embodiment.

FIG. 7 depicts yet another screenshot of a web portal of the system according to an exemplary embodiment.

FIG. 8 is a schematic of a general overview of exemplary aspects of the system according to an exemplary embodiment.

FIG. 9 is a schematic of an exemplary embodiment of the steps of the present invention.

FIG. 10 is a schematic of an exemplary embodiment of the Title Company portal of the present invention.

FIG. 11 is a schematic of an exemplary embodiment of the Real Estate Agent portal of the system.

FIG. 12 is a schematic of an exemplary embodiment of the Seller portal of the system.

FIG. 13 is a schematic of an exemplary embodiment of the Buyer portal of the system.

FIG. 14 is a schematic of an exemplary embodiment of the New Lender portal of the system.

FIG. 15 is a schematic of an exemplary embodiment of the Real Estate Broker portal of the system.

FIG. 16 is a schematic of an exemplary embodiment of the Vendor portal of the system.

FIG. 17 is a schematic of an exemplary embodiment of the Title Underwriter portal of the system.

FIG. 18 shows an overview of exemplary aspects of the escrow platform according to one embodiment.

FIG. 19 shows an overview of exemplary aspects of the escrow platform according to one embodiment.

### DETAILED DESCRIPTION OF THE INVENTION

This system generally consists of methods and apparatus for performing transparent, unified and simultaneous financial transactions. In certain exemplary embodiments, these transactions relate to the financing and sale of real estate or other large scale purchases. The systems and methods may also relate to transparent automated reconciliation of financial transactions, including funding transactions and escrow transactions.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the system.

The apparatus, methods, and system provided herein provide a financial transaction process that improves efficiencies over the prior art methods. This may include a computer, server or other electronic device that serves as a clearinghouse between multiple tranactors, providing near-real-time or real-time information regarding and processing of financial transactions. The transactors can include buyers, sellers, lenders, banks, insurance companies, attorneys, underwriters, and the like, as described elsewhere herein. The presenet apparatus, systems and methods concern the unification of the information and transaction around said central clearinghouse so as to provide the transactors with information as well as facilitate and perform financial transactions, as will be demonstrated in the embodiments disclosed herein.

As described U.S. Provisional Application 61/642,011, filed May 3, 2012 and hereby incorporated by reference, some exemplary embodiments provide a payment platform and method for the automated reconciliation of payments between payor and payee that combines an invoice and a payment into a single instrument. As further described in U.S. Provisional Application 61/788,503, filed Mar. 15, 2013, further exemplary embodiments address the transparent creation and facilitation of escrow holdings. Although the certain exemplary embodiments center on automated reconciliation, certain exemplary embodiments of the system can also comprise several other notable features, such as the authentication of user identification, the storage of digital signatures and supporting documentation in a secure environment, providing transparency to the appropriate parties to the transaction, automated pre-reconciliation, automated post-reconciliation, and the combining of an approved invoice to an electronic payment to ensure the finality of the payment.

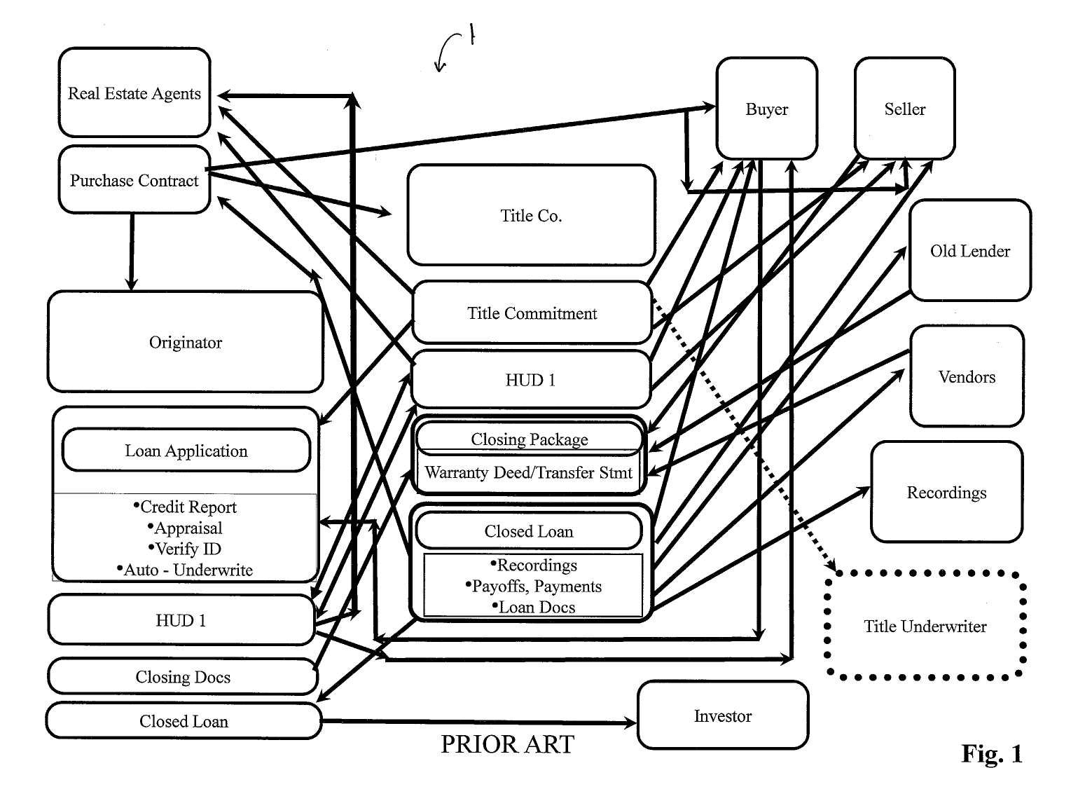

As seen generally in FIG. 1, the current, prior art system 1 for real estate transactions is decentralized and involves independent communication between myriad parties to the transaction, including between buyers, sellers, lenders, vendors, recorders, underwriters, investors, loan originators, real estate agents, and title companies. This independent communication involves a further subset of individual documents, contracts, titles, applications, reports, and the like. Because there is no centralized clearing house for this process at present, mistakes and fraud can be prevalent problems.

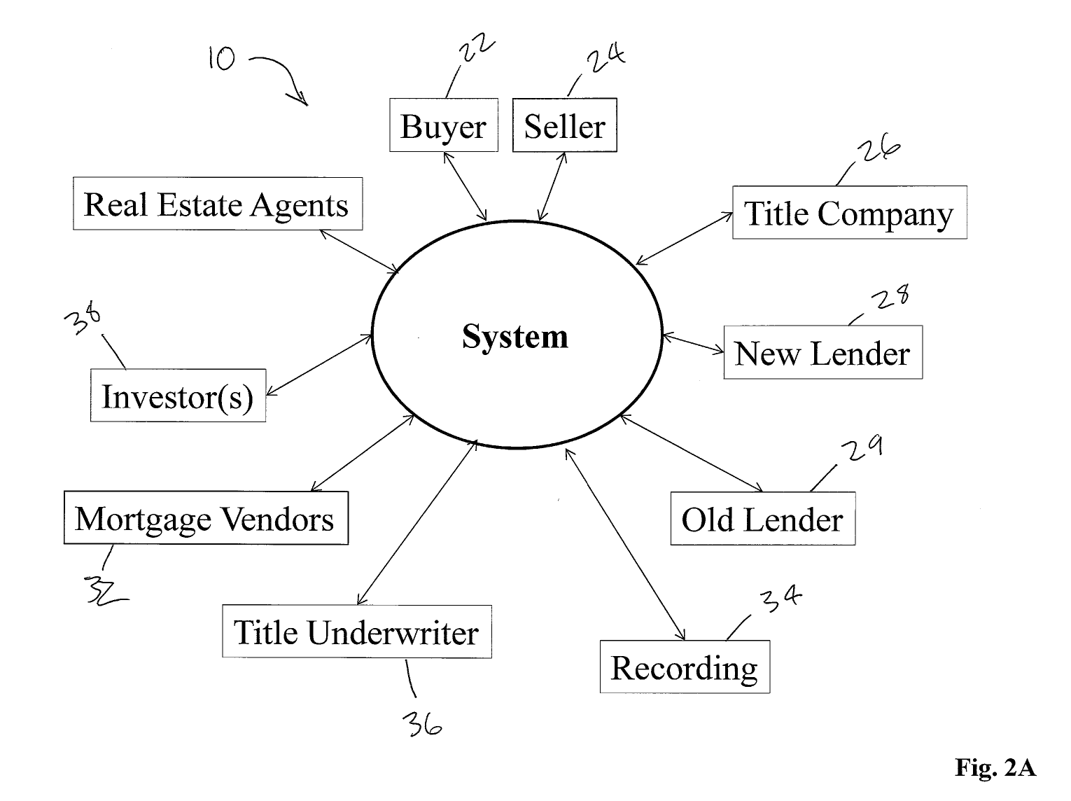

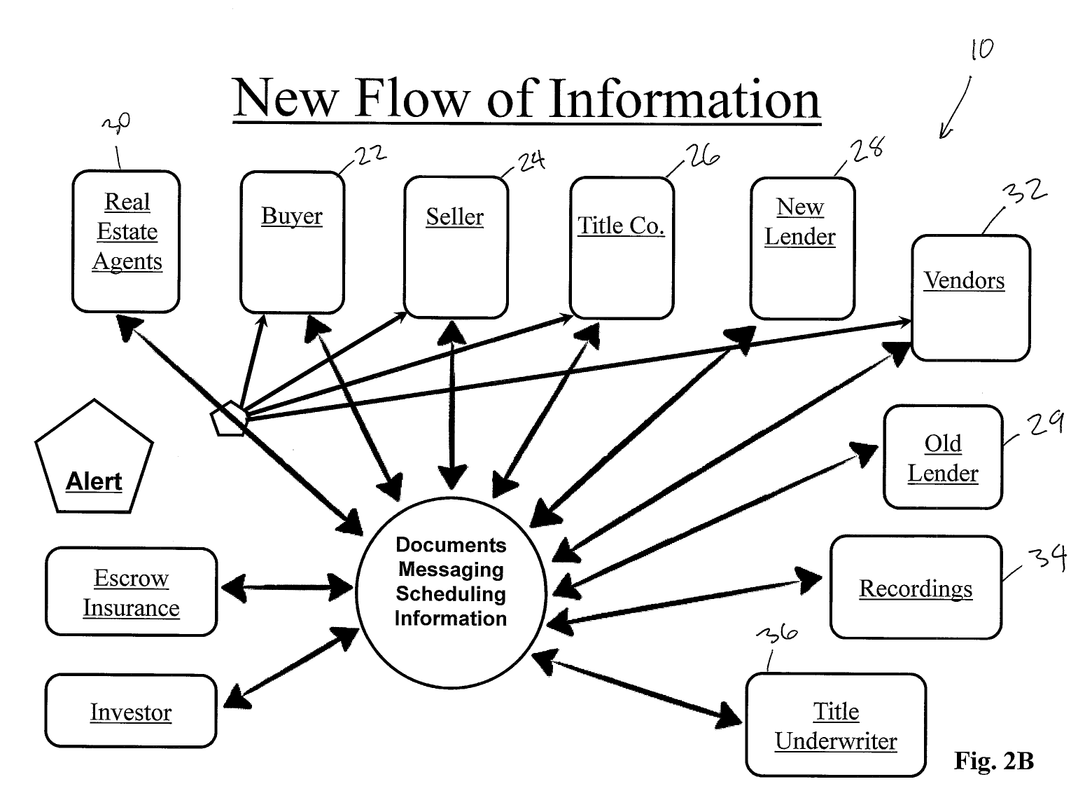

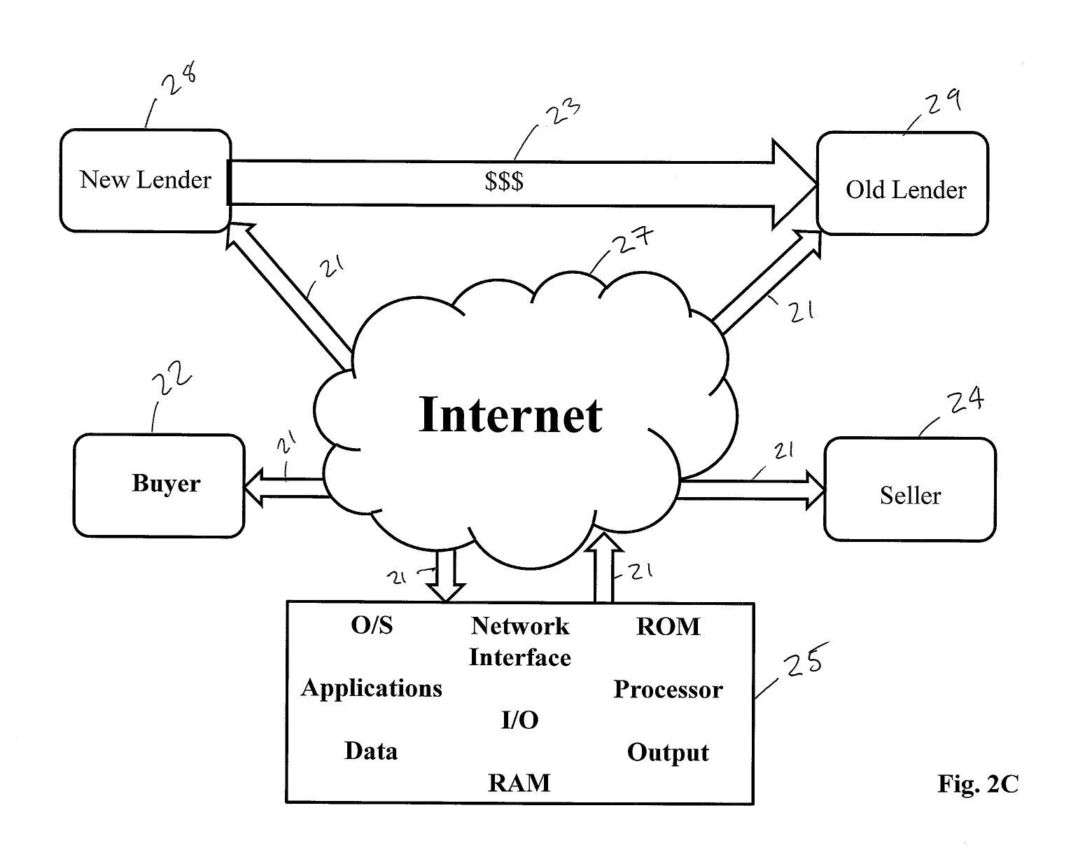

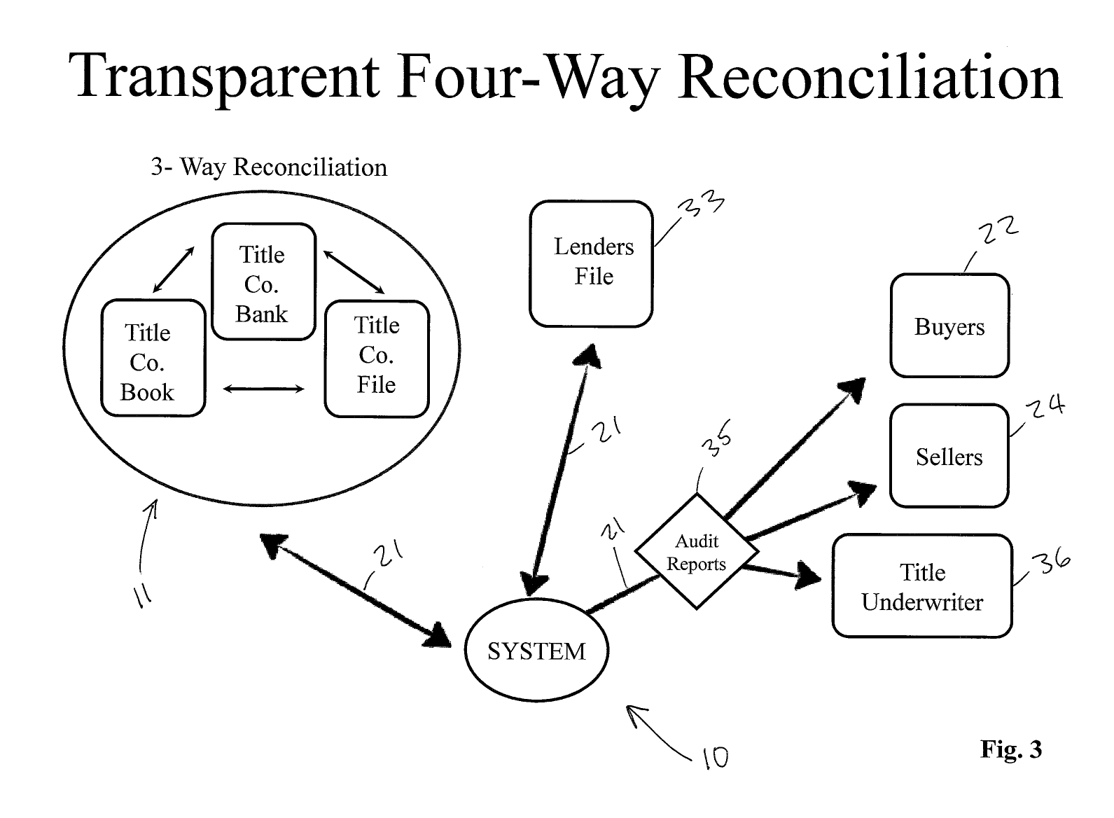

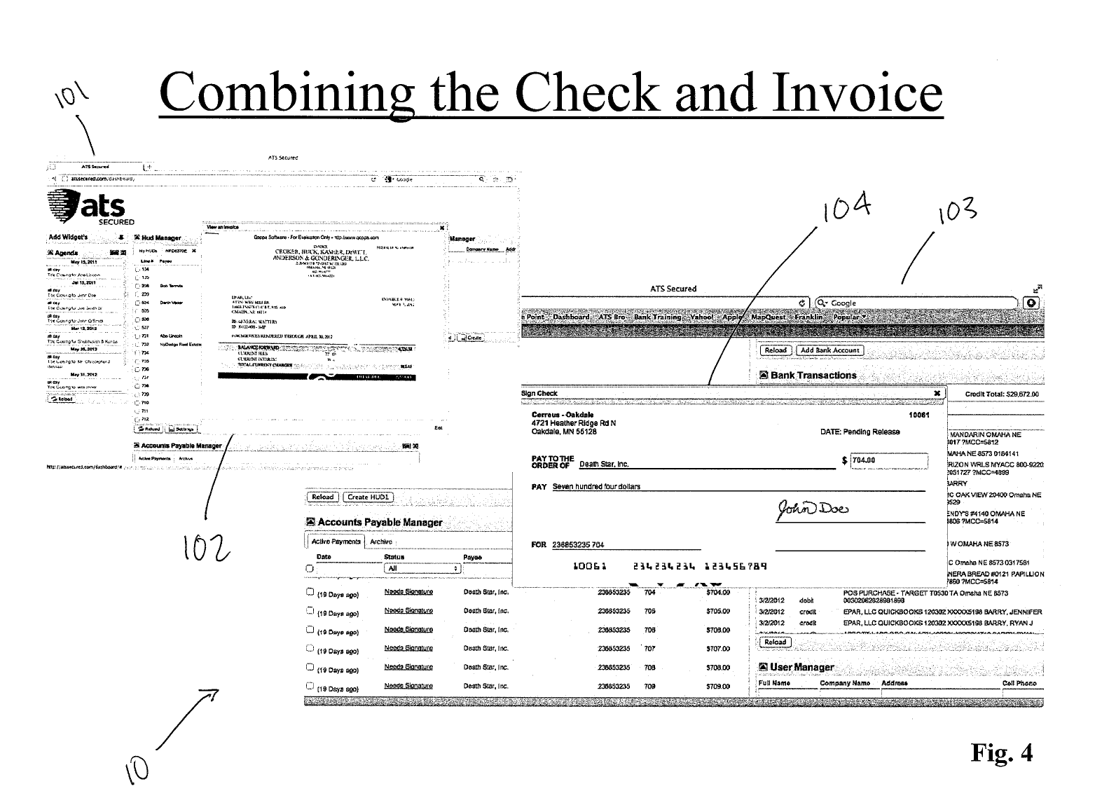

As shown in FIGS. 2A-3, the transaction system represents an improvement over the complex and decentralized process currently available. The transaction system, or “platform,” encompasses a number of steps, documentation of which are presented (or “pushed”) to the relevant individual parties to the transaction when non-confidential (as best shown in FIGS. 4-7), so as to increase transparency and reduce fraud and mistake.

As will be appreciated by one of skill in the art, the various aspects of the platform described herein may be embodied as a method, a data processing system, or a computer program product. Accordingly, those aspects may take the form of a hardware embodiment, a software embodiment or an embodiment combining aspects from both software and hardware.

Such exemplary aspects may take the form of a computer program product stored by one or more computer-readable storage media having computer-readable program code, or instructions, embodied in or on the storage media. Any suitable computer readable storage media may be utilized, including hard disks, CD-ROMs, DVD-ROMs, optical storage devices, magnetic storage devices, solid state storage devices and/or any combination thereof. Further, various signals representing data or events as described herein may be transferred between a source and a destination in the form of electromagnetic waves traveling through signal-conducting media such as metal wires, optical fibers, and/or wireless transmission media (e.g., air and/or space).

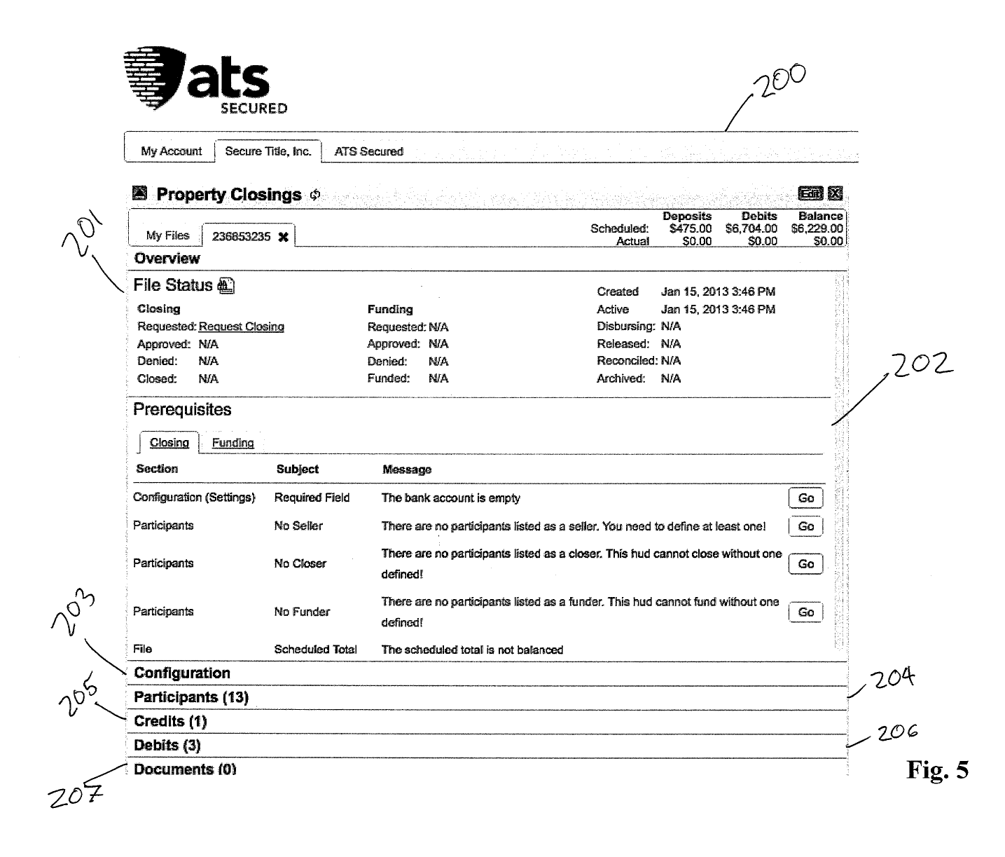

In FIG. 4, for example, a digital check 104 can be seen by both the payor and payee in real or near-real time as it is “cut.” The transaction system 10 encompasses processes which can digitally scrub or otherwise obscure all confidential or sensitive information from a document before it is presented to another party. These transparent transactions can be seen generally though distinct portals to the underlying computing device and software and thereby perceived by the various participants, as depicted further in FIGS. 5-17.

As seen generally in FIG. 2A-3, certain exemplary embodiments of the system 10 provide a unified platform for bringing buyers 22, sellers 24, title companies 26, lenders 28, 29 real estate agents 30, mortgage vendors 32, recorders 34, underwriters 36, and investors 38 together by way of the computer or server 25 of the system 10 to create unified documents 102, 104, as depicted for example in FIG. 4, and reduce fraud and mistake. The ability of the transaction system to create payments and records simultaneously by way of digital interface allows for the use of a more coordinated and streamlined process. Each of the individual participants may review, authorize and sign all the required documents by way of the present system 10. As would be clear to one of skill in the art, other embodiments and combinations of participants are possible. The transparency of the transaction from the perspective of each participant is controlled by the system, so that each participant is kept appraised of aspects relevant to that participant by the system. In certain embodiments, this appraisal is passive, while in other embodiments, the appraisal is active, for example by notification.

FIG. 2B depicts generally an exemplary embodiment of the transaction system. In these exemplary embodiments, as opposed to the prior art methods of conducting transactions, the system serves as a single “set of books,” wherein all required documentation is stored in a singular digital or virtual location, such that the interested parties can each have transparent access to pertinent information. In certain embodiments, necessary alerts can be automatically generated notifying interested parties of potential problems, so that all of the documentation can be viewed by the interested or relevant party so as to reduce error, fraud and the like.

FIG. 2C depicts exemplary embodiments of the system 10 comprise a computer or server 25 having, for example, an operating system, applications, data, a network interface, I/O, RAM, ROM, and a processor in communication by way of a secured internet 27 connection 21 or connections (LAN or WAN, for example) with other operative portals and transactors. In the exemplary embodiment depicted in FIG. 2C, a buyer 22, seller 24, a new lender 28 and an old lender 29. The system provides access for the transactors—here the buyer, seller, new lender and old lender—to the operation of the transaction and can effectuate, for example, transactions, such as document production, transfers of funds 23 (shown here between the new and old lender), verifications, and other processes, as required by the specific transaction, by way of the secure connections.

FIG. 3 depicts an exemplary embodiment of the system 10, known as four-way reconciliation, wherein the system by way of the portals or connections 21 can provide certain transactors 22, 24, 36 with specific information, such as audit reports 35, as well as produce documentation for other transactors, such as the lender's file 33, and unify the three-way reconciliation method 11 of the title company with the file of the lender.

Typically, a three-way reconciliation is a method for discovering shortages—intentional or otherwise—and charges that must be reimbursed or any type of errors or omissions that must be corrected in relation to an escrow trust account. This requires the escrow trial balance, the book balance and the reconciled bank balance to be compared. If all three parts do not agree, the difference shall be investigated and corrected. This system tends to invite error and fraud because the books being kept by the title company based on the HUD form are separate from the books being kept by the lender. With multiple sets of books, the chance for error or fraud is inherently higher.

The present system thereby presents a four-way reconciliation system, wherein the books of at least the title agency and lender are unified by the system so as to reduce or prevent fraud and mistake. This is one of the principal advantages of the present system over the prior art methods.

In certain exemplary embodiments, and as shown in FIG. 4, the system 10 facilitates automated reconciliation. As depicted in FIG. 4, the system 10 provides the payee, by way of their portal 101, the ability to upload an invoice or create an invoice 102, electronically submit the invoice to the payor through a secure connection by way of the payor portal 103, and then allow the payor to approve the invoice and automatically generate a check to the payee, the payor digitally signs the check with a digital signature, and in certain embodiments send the information to another user for dual control of funds, or in other embodiments provide the information directly to the payee who endorses the back of the check with a digital signature and then, in certain embodiments, direct deposits it into a bank account of choice. Using these embodiments, the funds are available the next day, unlike under a traditional ACH method.

FIG. 5-7 show additional screenshots of the system as observed by individual users relevant to certain embodiments. For example, FIG. 5 shows a portal to the system 200 showing the current relevant information regarding the file status 201, the prerequisites 202, the configuration 203, the other participants 204, the credits 205, the debits 206, documents 207 and other relevant transaction information and operations. As one of skill in the art would readily appreciate, the graphical user interface can include tabs, dropdown menus and the like, as are well known to makers of GUIs.

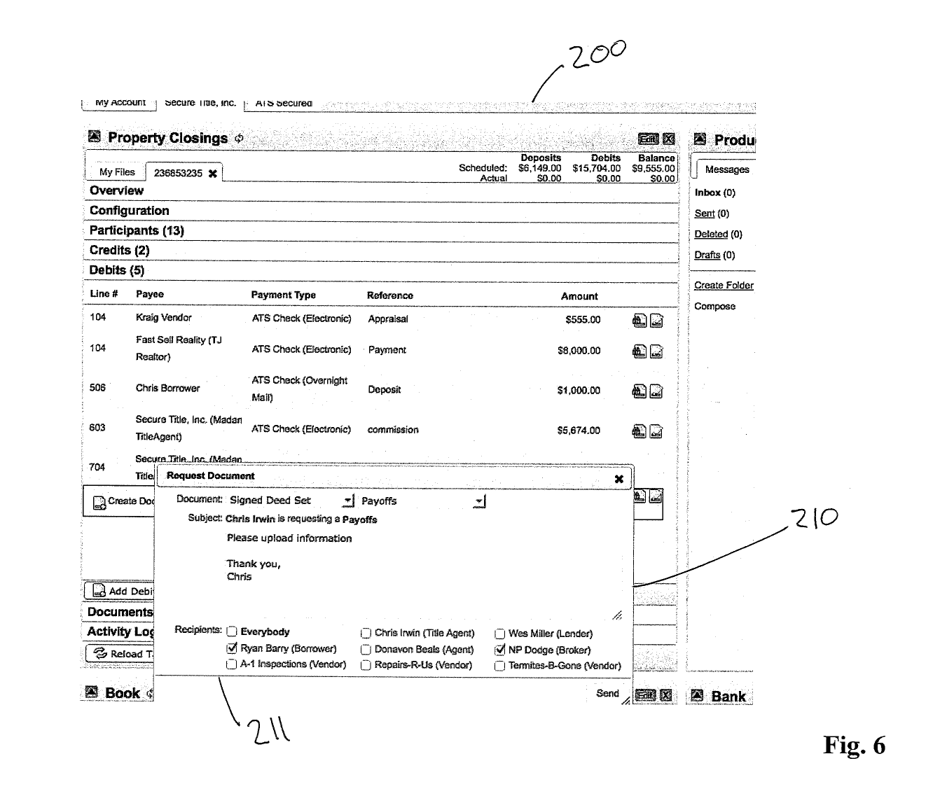

FIG. 6 depicts a portal 200 screenshot of yet another exemplary embodiment of the system showing the ability to request a document 210 by way of the system. In certain exemplary embodiments, the requestor can select individual recipients 211 relevant to the particular document. In certain exemplary embodiments, the system will present limited lists of possible recipients to maintain confidentiality and other security precautions, as would be apparent to one of skill in the art.

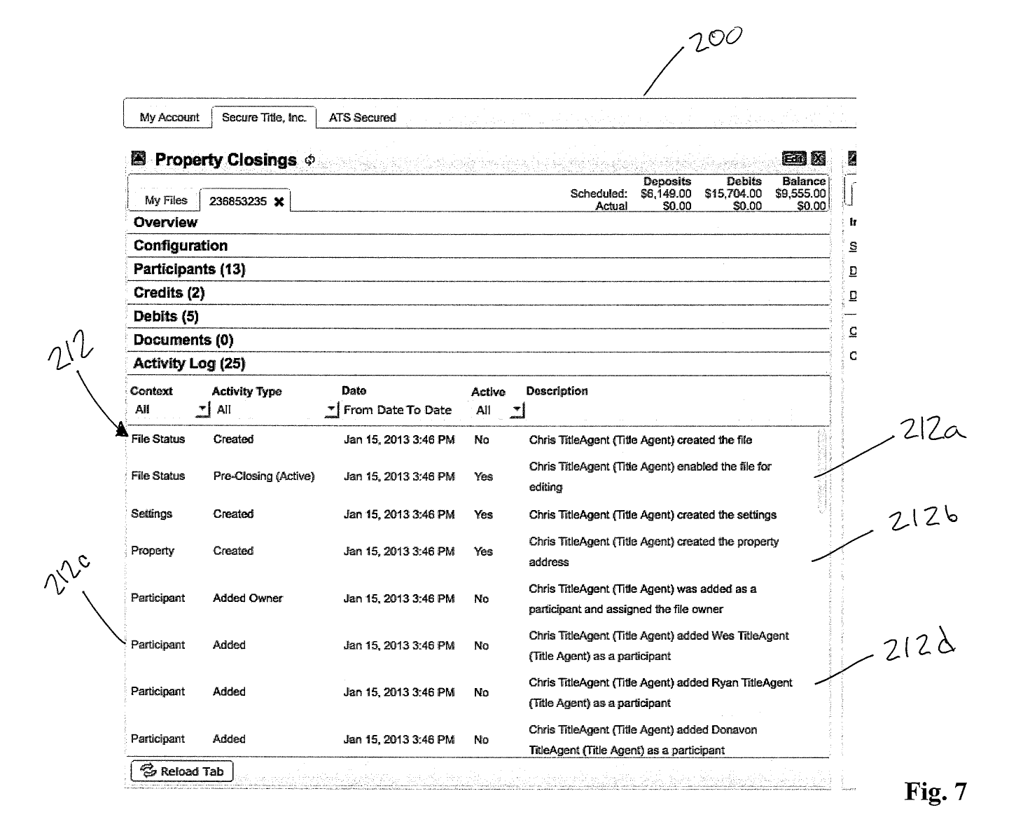

FIG. 7 depicts yet another portal 200 screenshot of an exemplary embodiment of the system showing the activity log 212 of the system. In certain exemplary embodiments, the system will create line items or other graphical methods of displaying the current progress of individual action items 212a, 212b, 212c, 212d showing, for example the context, activity type, date, status and description. As would be readily apparent to one of skill in the art, other displays are possible.

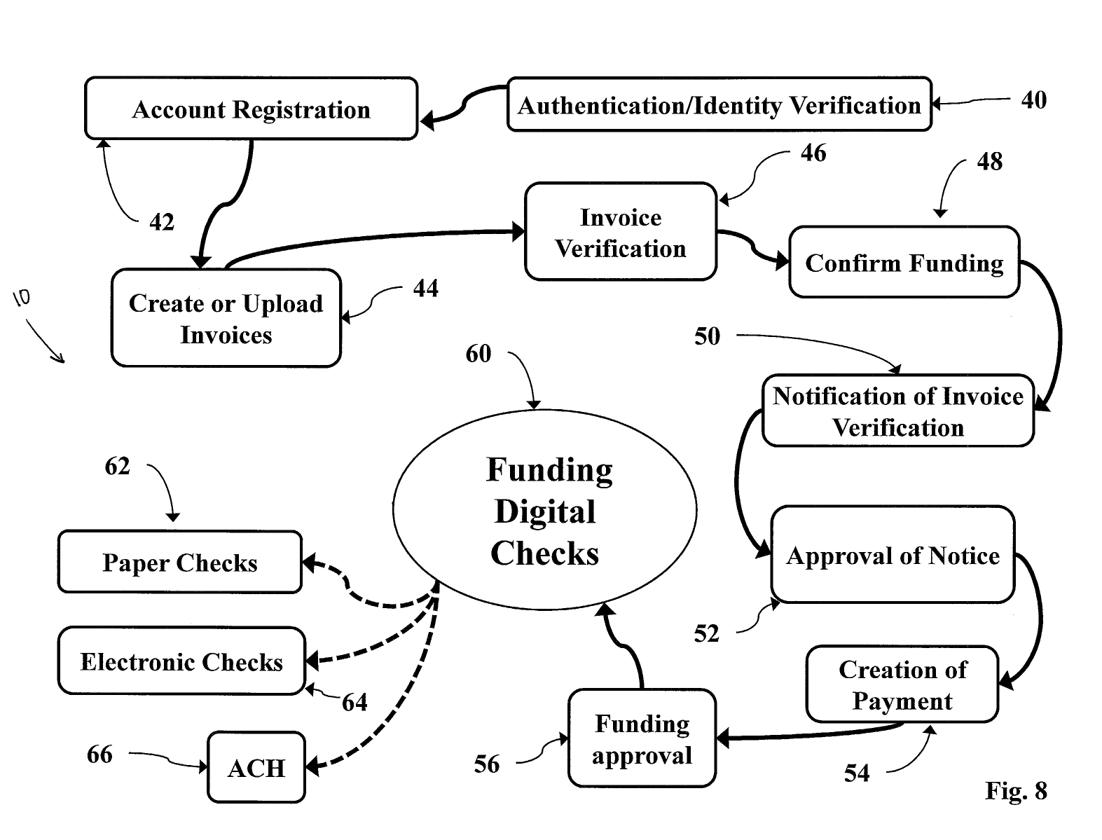

Turning to the function of the system 10 over time according to certain embodiments, FIG. 8 depicts an overview of certain aspects of the transaction system 10, according to certain embodiments. In these embodiments, each of the relevant transactors may be given access to the portions of the transaction relevant to them by way of the portals described above. For example, in exemplary embodiments, one step may be authentication 40, wherein the parties to the transaction enter a series of validation methods by way of the system, including credit checks, identification checks, and bank account verification, allowing for both automated and manual underwriting of the system's users. In certain embodiments, another step is account registration 42, wherein users may register bank and other accounts for pre- and post-reconciliation and for proper payment creation or receipt. A third aspect of certain exemplary embodiments is invoice creation 44, wherein the payee produces and submits an invoice to a payor by way of the system.

Certain exemplary embodiments of the system comprise invoice verification 46, wherein the platform confirms at least one of: whether the payor is expecting to make the payment to the payee as created on the invoice; whether the created payment amount is equal to the correct payment amount; and whether there are sufficient funds in the bank account to cover the created invoice. In certain exemplary embodiments, the system can also confirm 48 whether the funds in the bank account are earmarked for other items that are expected to be paid, or whether the funds are associated with the payment created on the invoice.

The system may further comprise notification of invoice verification 50, wherein proper notification is given to the payor and all users that the items on the created invoice have been verified. In yet further embodiments, the transaction system comprises an approval of notice 52, wherein the payor approves the invoice amount. Further embodiments of the system create a payment 54, in which an approved invoice 52 may be used to create the payment. In exemplary embodiments, the funds are then generally released by the payor and the payor's digital signature is captured by the system as an approval 56.

In certain embodiments this may be a multi-step process, depending upon the organization and dual control of funds within the system. Out of bounds authentication may be used. Notification of payment approval and funds release is then generally sent to the payee and all other parties to the transaction as desired, and the payee elects how to receive 60 the payment from a variety of methods, including using paper checks, electronic checks, or Automated Clearing House (“ACH”).

The following example is provided as an illustration of an exemplary embodiment of the system. If the payee elects paper checks 62, the platform will send the file and payment instructions to a check printing facility. The payment will arrive to the payee via USPS, FedEx, or some other carrier. The payee will then deposit the paper check in their bank of choice using a standard deposit method. If the payee elects an electronic check 64, the payee will endorse the check with their digital signature. Payment instructions will then be provided to a third party payment provider for final settlement through the traditional banking system. The payment provider may elect to send the check image to the originating bank for presentment to the Federal Reserve, or to an Originating Depository Financial Institution (“ODFI”) as used in a traditional Remote Deposit Capture process, or directly to a check clearing account with the Federal Reserve. The payor can require in conjunction with digital check receipt process above that the payee digitally endorses a release to validate receipt of payment in full for goods or services provided. If the payee elects ACH 66, the payee will endorse the check with their digital signature. The check is then converted into an ACH and funds are deposited via NACHA. One of skill in the art would understand how these methods of payment would work. Following payment, the platform automatically reconciles the payment with the bank to complete the process. Though these steps constitute an exemplary embodiment of the system, some may be omitted and others added, depending on the desired application and specific participants. One of skill in the art would understand how this is done.

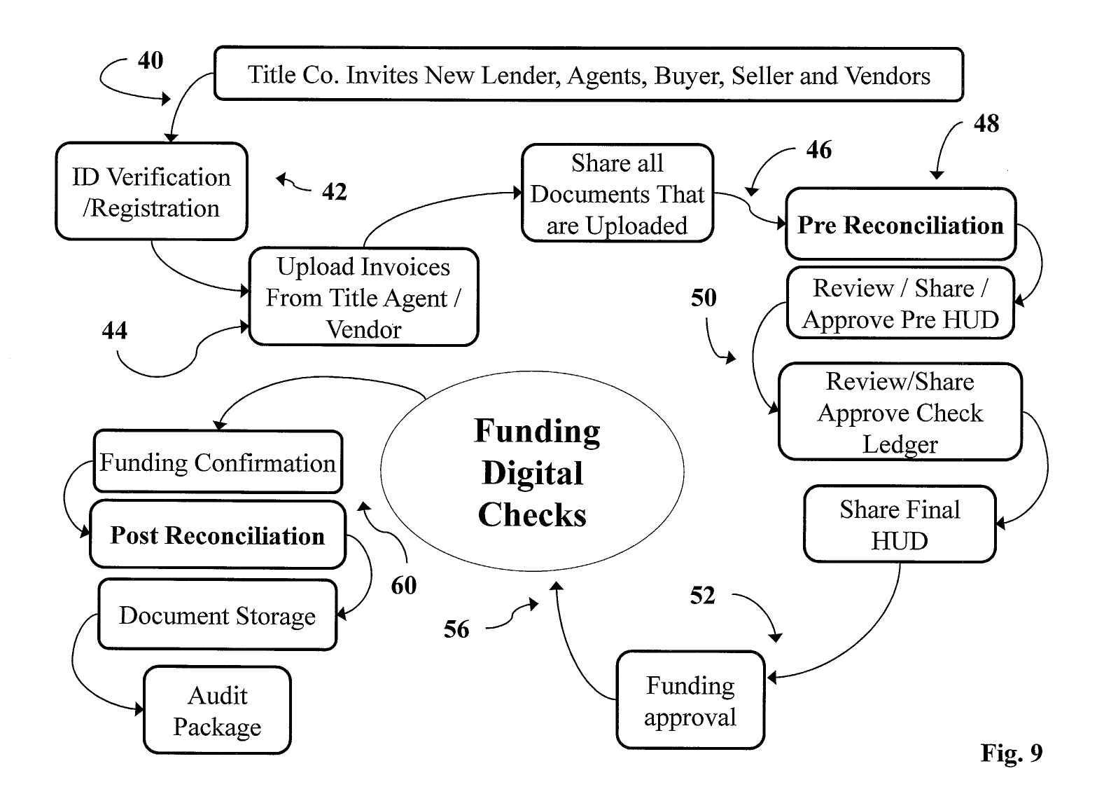

FIG. 9 generally depicts an exemplary embodiment of the system. FIG. 9 depicts a flowing representation of the transaction system as applied to exemplary steps and potential participants. As would be clear to an artisan, other configurations of participants and steps are possible. In this example, the Title Company invites a New Lender, Agent, Buyer, Seller and Vendors to participate in the system. After entering the system, in certain embodiments they are authenticated 40 and registered 42. In certain embodiments, invoices are subsequently created 44 and uploaded to the platform, where they can be shared, verified, 46 and confirmed 48 for reconciliation, depending upon the requirements of the financial transaction. In certain embodiments, when the invoice is confirmed 50, funding is approved 52, and the payment is created, 54, and the digital signature is captured by the platform 56, and the payment is generated and dispersed 60 to the payee or payees.

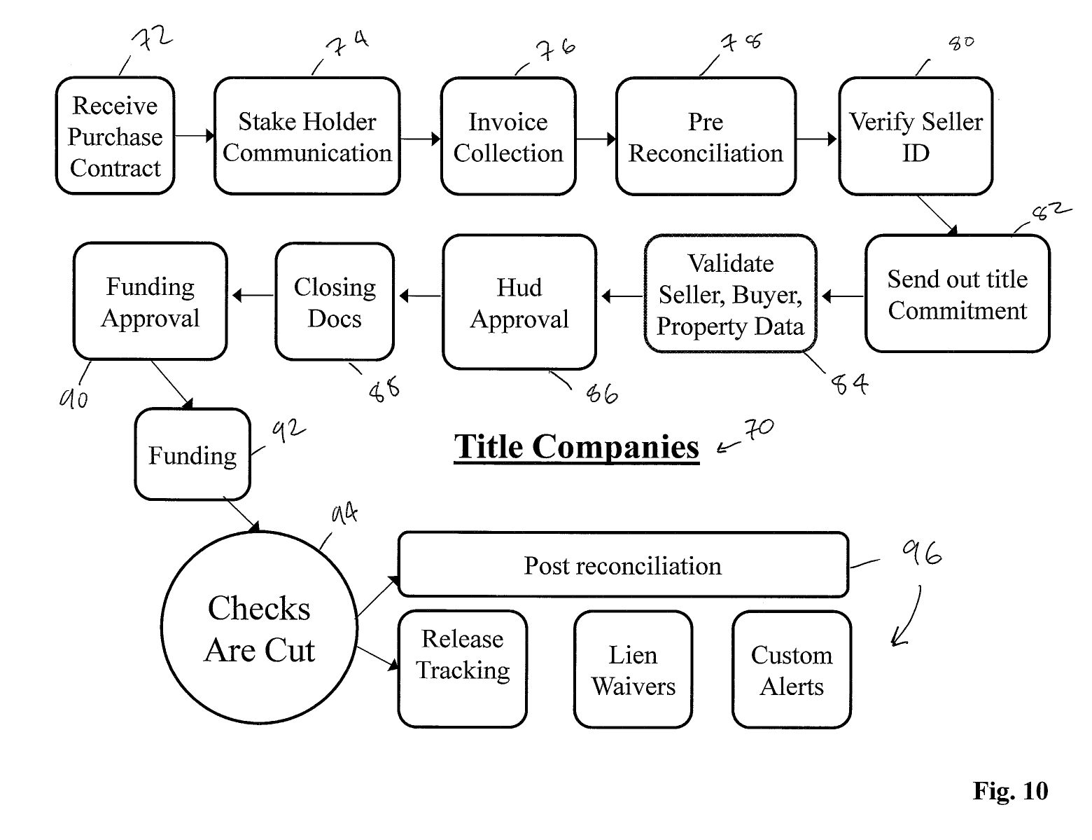

An important aspect of exemplary embodiments of the system are the specific views, or portals, into the process with the essential features for each type of transactor, as depicted above in reference to FIGS. 5-7, and again generally in FIGS. 10-17 as flowcharts of information displayed to specific kinds of transactors so as to track key aspects in real time. No specific kind of transactor is required for the system to operate, rather, the system is designed so as to provide at least transactor with the transparent access to information about the financial transaction. The various embodiments shown in FIGS. 10-17 are provided as examples, and are no way limiting in scope to the invention.

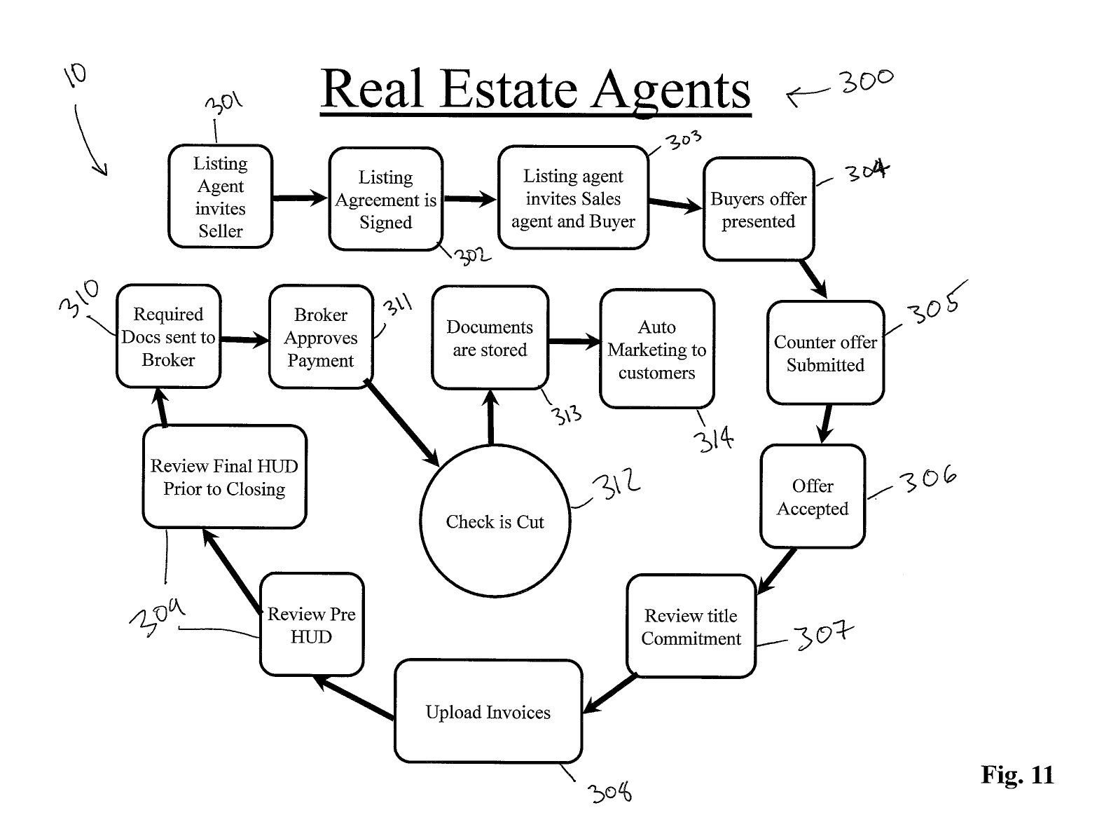

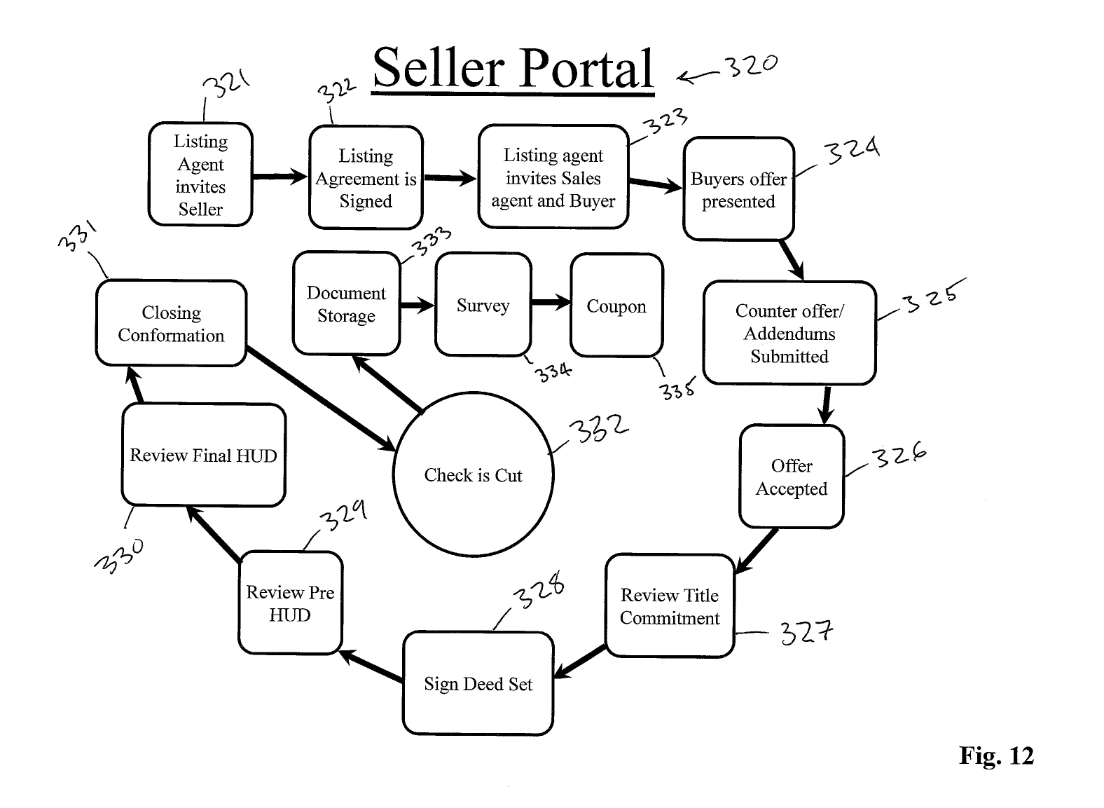

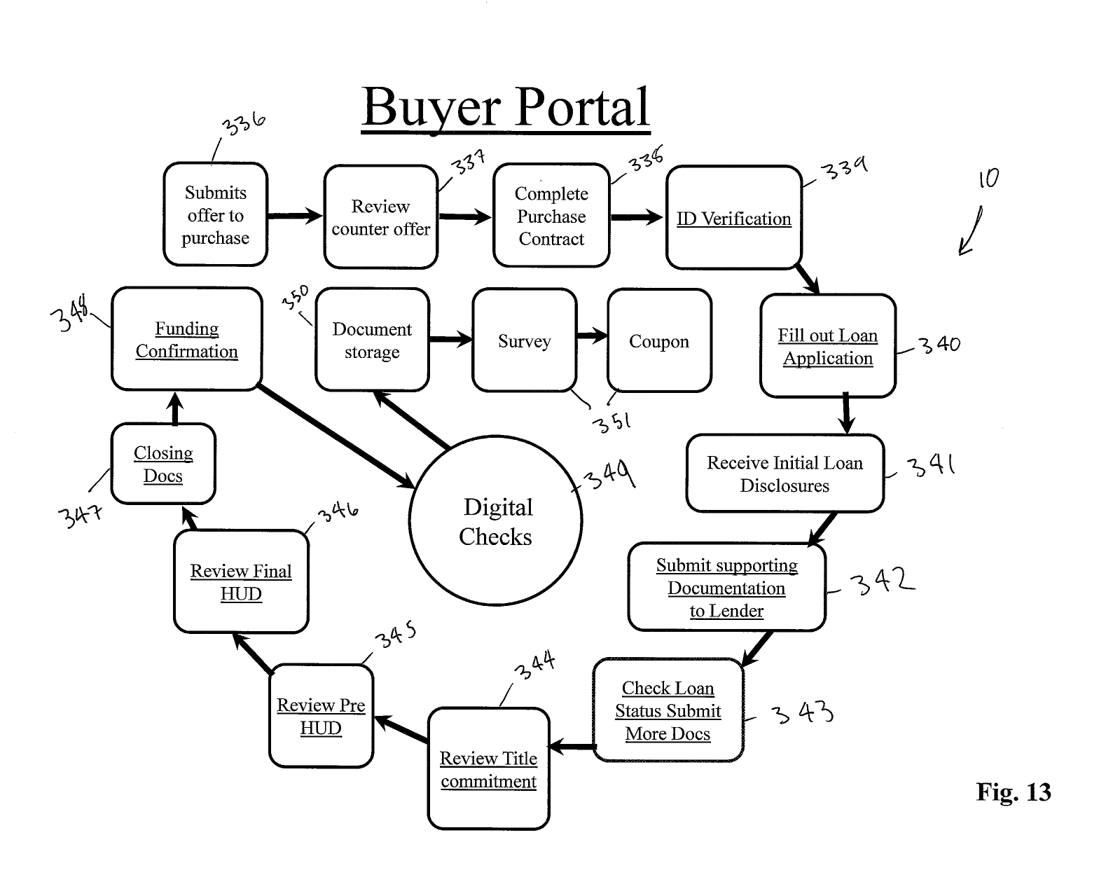

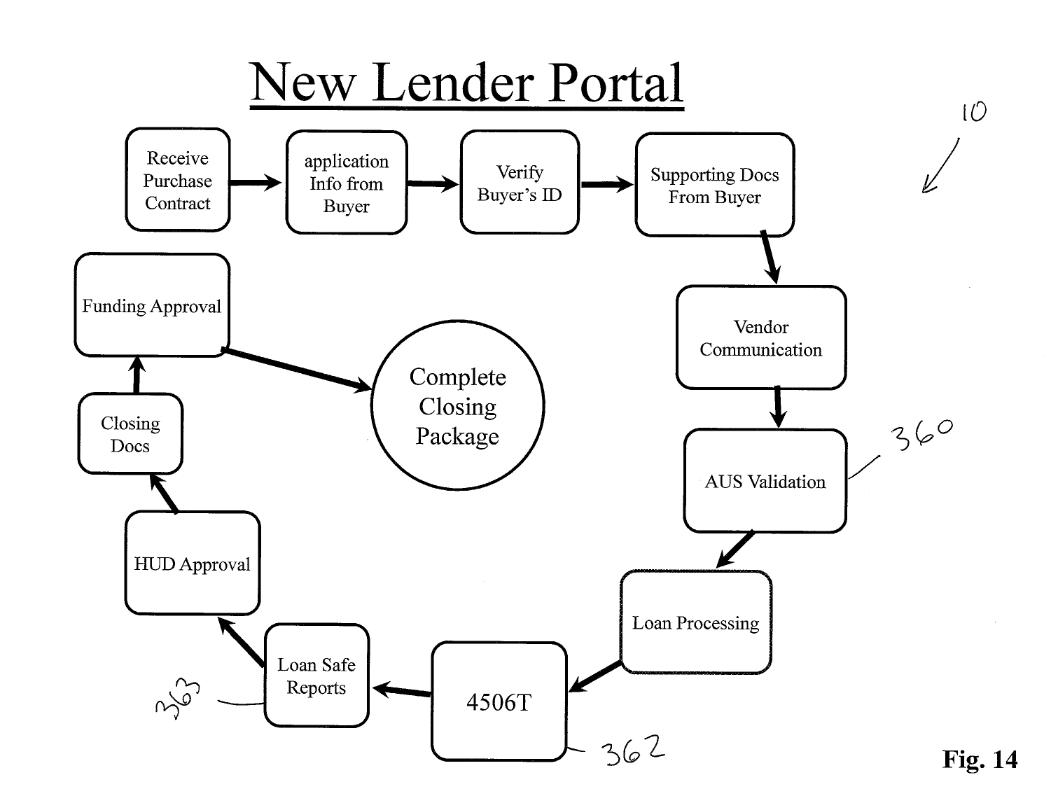

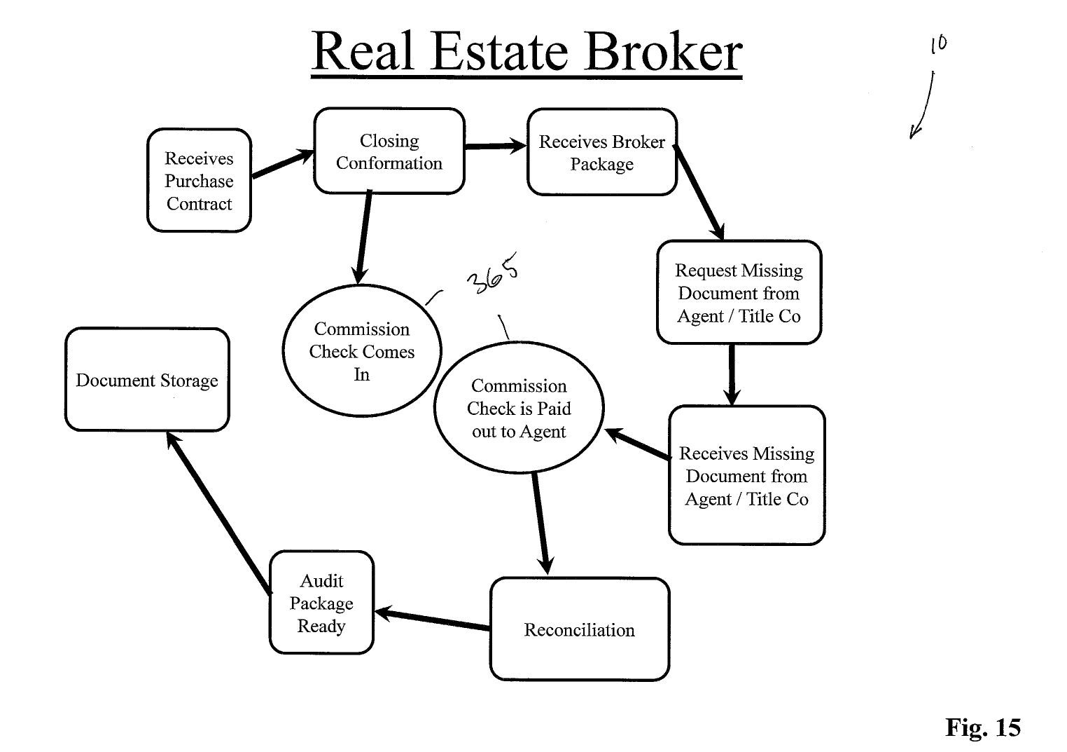

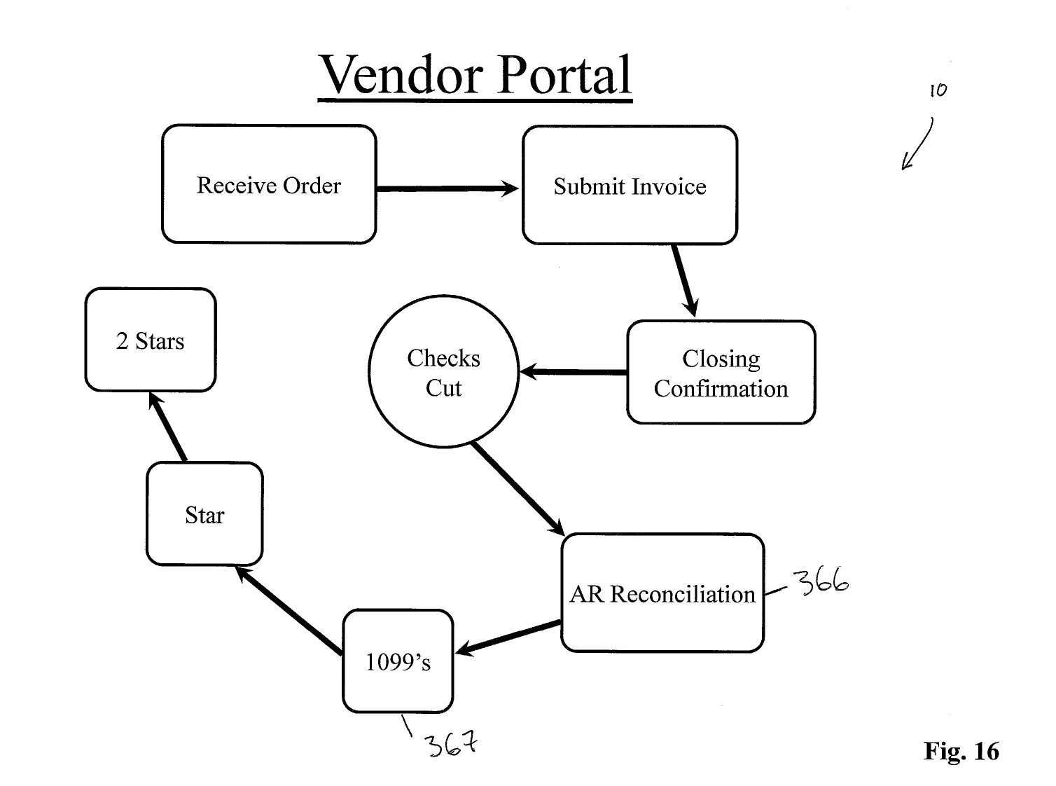

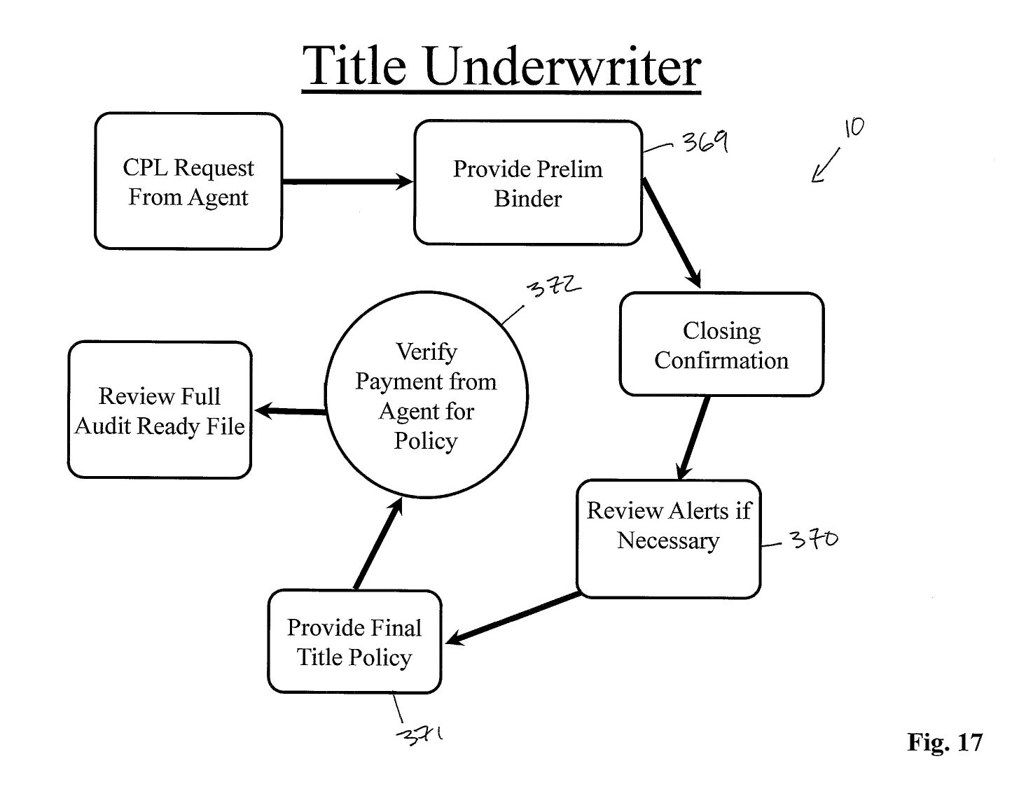

FIGS. 10-17 show alternate exemplary embodiments of the system presenting portals for specific participants. Other embodiments and configurations are possible. The transaction system pushes all of the non-confidential information to all interested parties, thereby increasing transparency. FIG. 10 shows the system presenting a portal designed for a Title Company, FIG. 11 shows the system applied to a Real Estate Agent, FIG. 12 shows a Seller portal, FIG. 13 a Buyer portal, FIG. 14 a New Lender portal, FIG. 15 a Real Estate Broker portal, FIG. 16 a Vendor portal, and FIG. 17 a Title Underwriter portal. One of skill in the art would understand which of these steps may be pertinent to each of the participants. Certain features of each portal are specific to the specific needs of the individual participant's role in the process.

For example, in the flowchart of the exemplary embodiment depicted in FIG. 10, a title company 70, by way of the system is a transactor to a transaction involving the lender, agent, buyer, seller and vendors. In some embodiments, the title company may be in operative communication with the system to view or perform certain of the following steps: receiving the purchase agreement 72, communicating to stake holders 74, collecting individual invoices 76, participate in the pre-reconciliation process 78, verify the identity of the seller 80, communicate the title commitment 82, validate the property information 84, obtain HUD approval 86, view or add to the closing documents 88, view the funding approval 90 and funding 91, the cutting of the checks 94, and the post-reconciliation process 96. In certain exemplary embodiments, the system is capable of populating a HUD form, or using a HUD form to retrieve identification information about various transactors for use in the financial transaction.

A flowchart of an exemplary embodiment of the system 10 as viewed by a real estate agent portal 300 is depicted in FIG. 11. In this embodiment, by way of example, a real estate agent invites a seller 301, the listing agreement is signed 302, the listing agent invites the sales agent and buyer 303, the buyer's offer is presented 304, a counter offer is submitted 305, the offer is accepted 306, the title is reviewed 307, the invoices are uploaded 308, the HUD review takes place 309, the required documentation is sent to the broker 310, who then approves it 311, and the final check is cut 312, the documents are stored 313, and marketing 314 may be automatically initiated. Although each of these features may be displayed to and/or supplied by the real estate agent, in certain embodiments some may be omitted and others added. While the steps may vary, one crucial aspect of the system's application is the ability for the real estate agent to view the steps of the transaction simultaneously or nearly simultaneously during the duration of the process, all the while requesting and verifying information relevant to the agent so as to facilitate the transaction and reduce error and fraud.

FIG. 12 depicts a flowchart of an exemplary embodiment of the system featuring a Seller portal 320. In this embodiment, by way of example, again a real estate agent invites the seller 321, the listing agreement is signed 322, the listing agent invites the sales agent and buyer 323, the buyer's offer is presented 324, a counter offer is submitted 325, the offer is accepted 326, the title is reviewed 327, the invoices are uploaded 328, the HUD review takes place 329, 330 the closing is confirmed 331, the final check is cut 332, the documents are stored 333, and the seller may be presented with a survey 334 and coupon 335. Although each of these features may be displayed to the seller, in certain embodiments some may be omitted while others are added. While the steps may vary, one crucial aspect of the system's application is the ability for the seller to view and participate in the relevant steps of the transaction simultaneously or nearly simultaneously during the duration of the process.

FIG. 13 depicts an exemplary embodiment of the system 10 from the perspective of a Buyer portal. In this embodiment, by way of example, the Buyer submits and offer 336, in certain embodiments is able to review the counter offer 337 and complete the purchase agreement or contract 338, the system performs the steps of identification verification 339, in certain embodiments and when necessary, the buyer is able to complete a loan application 340, receive disclosures 341 and submit supporting documentation 342, as well as check the status of the loan and submit more documentation 343 as necessary. In certain exemplary embodiments, the buyer may review the title commitment 344, the HUD review 345, 346, the closing documents 347 and the confirmation of funding 348 by way of the system while they are being processed. In certain embodiments, the Buyer is then able to view the confirmation of the closing and the cutting of the final check 349. The buyer can then store and documents 350 as needed. As with the Seller, the Buyer may then be presented with a survey and/or coupon 351. Although each of these features may be displayed to the buyer, in certain embodiments some may be omitted while others are added. While the steps may vary, one crucial aspect of the system's application is the ability for the buyer to view and participate in the steps of the transaction simultaneously or nearly simultaneously during the duration of the process so as to prevent fraud and reduce error.

As stated previously, FIG. 14 depicts a flowchart showing potential steps presented in an exemplary embodiment of a New Lender portal, FIG. 15 depicts a flowchart showing potential steps presented in an exemplary embodiment of a Real Estate Broker portal, FIG. 16 depicts a flowchart showing potential steps presented in an exemplary embodiment of a Vendor portal, and FIG. 17 depicts a flowchart showing potential steps presented in an exemplary embodiment of a Title Underwriter portal. As is shown in those Figures, similar for each of the participants can be presented by the system 10 through their customized portals, though certain phases, such as AUS validation 360, IRS 4506T forms 362, loan safe reports 363, commission checks 365 and AR Reconciliations 366, 1099 Forms 367, providing ratings 368, providing binders 369, reviewing alerts 370, providing title policies 371 and verification of payment information 372.

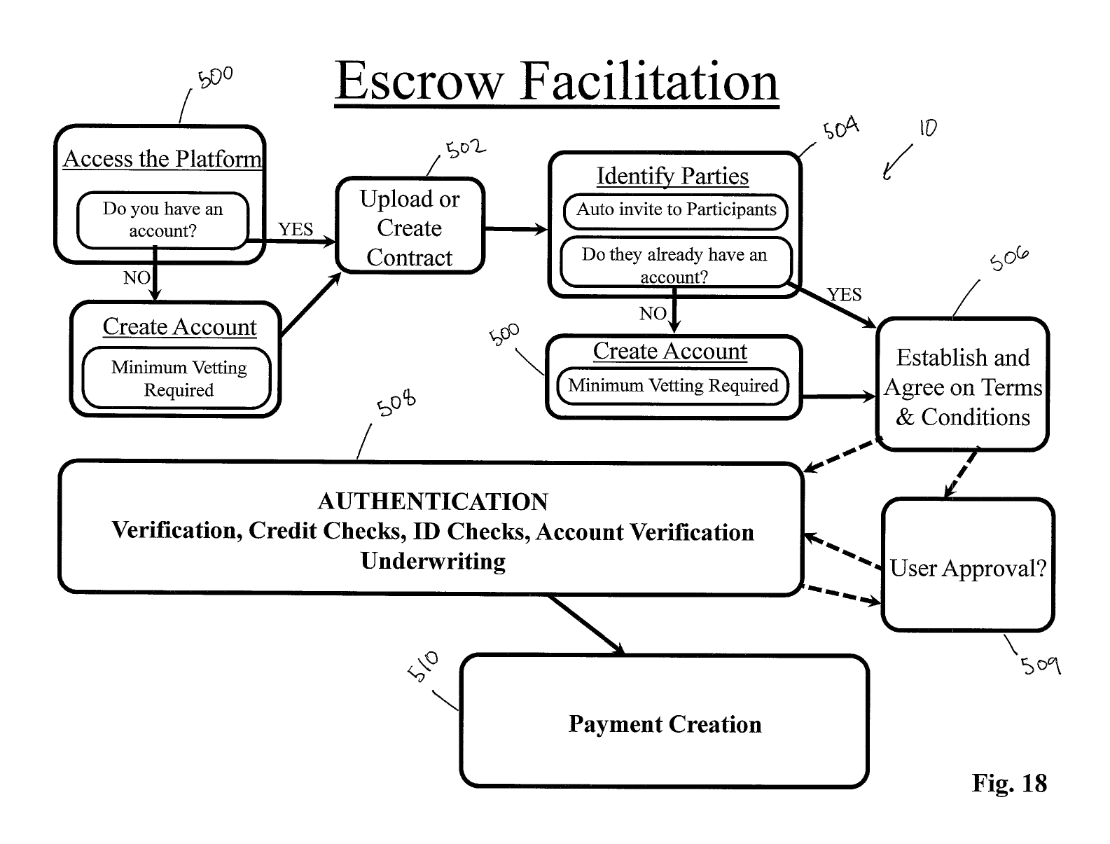

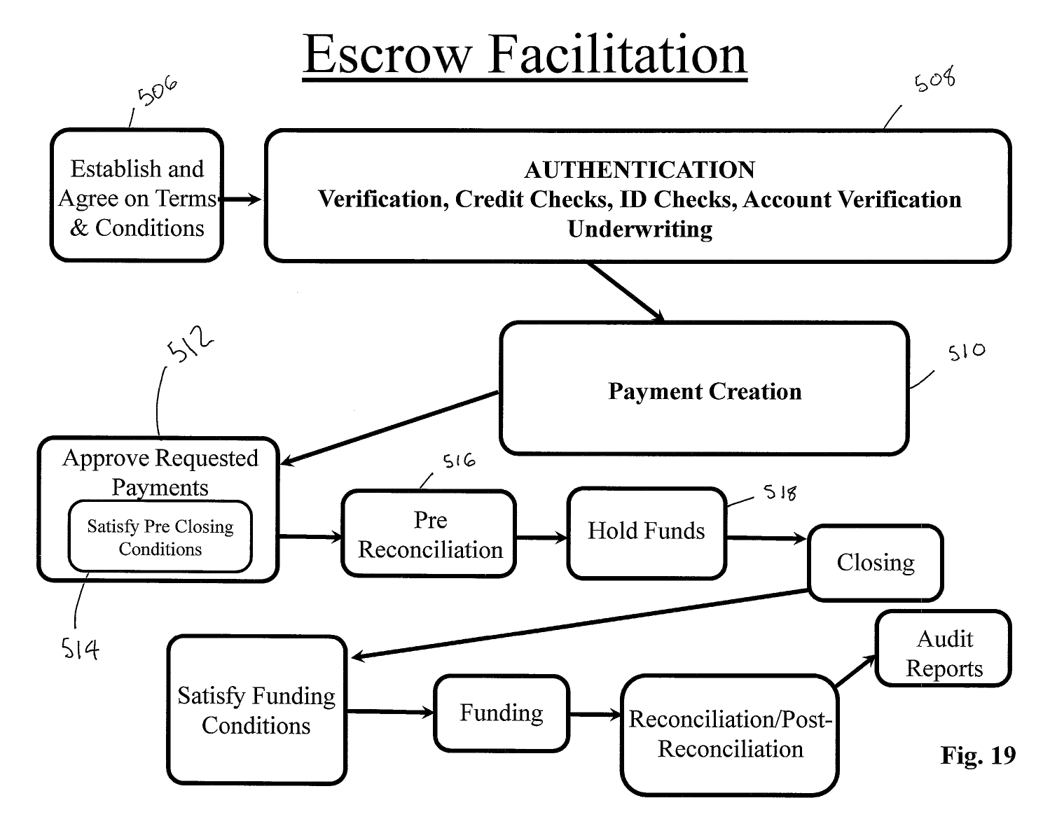

As shown in FIGS. 18-19, further exemplary embodiments of the system 10 relate to transparent transactions for escrow and payment risk mitigation. In these embodiments, the system comprises an automated process in which payments for goods or services that are exchanged over a period of time or once certain conditions are met, can be insured, guaranteed, or warranted transparently.

Traditionally, payments are initiated by the payor with little to no protection against fraud or errors. At times, goods or services are performed without timely payment or no payment at all. The escrow and payment system, or escrow platform, allows both the payee and payor to produce a contract with terms or conditions that must be met for payment to be made. The system further reconciles the payor's depository account verifying fund availability.

In certain implementations, funds can be held in the payor's depository account or can be transferred to a third party escrow agent. Once all appropriate parties have agreed that the terms and conditions have been met, an automated electronic payment is sent to the payee for end to end payment validation. The flexibility allows for transparency of the financial transaction information to a payee and payor, but also to appropriate other third parties such as, banks, insurance companies, vendors, Government regulators, and escrow agents.

In certain implementations of the system featuring the escrow platform, it is possible for an insurance company or other financial institution to offer an escrow insurance product, guarantee, or warranty on payments for escrowed goods or services to be made to the appropriate parties in a timely manner.

By way of example, and as depicted generally in the flow chart of FIG. 18-19, certain exemplary embodiments of the escrow platform comprise some of the following aspects. As would be apparent to one of skill in the art, not all aspects are required, and additional aspects may be implemented in certain embodiments.

In these exemplary embodiments the system 10 requires account creation 500 for all transactors, which can involve various degrees of vetting depending upon the type of transaction contemplated. In exemplary embodiments, it is not necessary that all transactors have an account to initiate the process, only that an account is eventually created.

Next, a platform transaction is initiated. In certain implementations this occurs when a contract 502 is entered into the system specifying the involved parties 504 and the terms and conditions for payment 506. Typically, at a minimum the payment terms 506 are a contract, but through the platform a payment item may also be tied to a contract.

In various implementations, there are multiple options such as: contract document(s) can be uploaded to system and shared with appropriate parties; terms of the contract entered into system and platform generates contract(s) that is/are shared with appropriate parties; and invoice terms entered into platform and an electronic check is automatically created pending approval by required interested parties. In other implementations, other options are possible, as would be clear to one of skill in the art.

Next, in exemplary embodiments the system requires authentication 508. In these implementations, all participating parties must pass minimum verification standards as a threshold for using the escrow platform. A series of validation methods including credit checks, ID checks, and bank account verifications can be requested. This process is flexible allowing both automated and manual underwriting of users. The terms and conditions may require additional verification standards at a later point in system.

Another aspect of certain implementations of the escrow platform is that the terms and conditions—when required—must be cleared by appropriate users 509. This may include shipping terms, appraisals, lien related items, or any other terms specified in the contract. The appropriate documentation to satisfy terms is uploaded to the platform for transparency to appropriate parties.

In certain implementations, users are required to register valid bank account(s) or other funding sources for pre- and post- reconciliation. In these implementations, the payor must identify the source of funds. If a third party escrow agent is used then the escrow account must be registered to show incoming and outgoing funds for each specific transaction.

Another aspect of the platform is proper payment creation 510 and approval 512 following the satisfaction of pre-closing terms and conditions 514. Additional conditional terms may be included as part of the contract for any items that need to be verified prior to closing and funding of the contract. Any invoices for payments associated with the transaction are uploaded into the platform for approval. An interested party can also do a change request if they do not approve the information, or documentation that has been uploaded on the platform. The change request process then becomes an audit log of the steps required to clear terms and conditions.

As with other embodiments, another key aspect of the escrow platform may be pre-reconciliation 516—a multi-transactor reconciliation process that determines available funds and scheduled withdrawals based on hierarchy rules established by interested third parties. By way of example, when a payor is expecting to make a payment to a payee, the system verifies that the payor has sufficient available funds on demand in an actual depository account, and that the amount scheduled to be disbursed to the payee matches what the payor is expecting to pay in his/her ledger, and matches what the payee is expecting to receive per his/her ledger. The system can further reconcile expected payments as part of a file or an entire book.

In certain implementations, when closing is approved and the payor funds can be: placed on hold 518 in the payor' s account; transferred to a designated third party escrow agent; or transferred to other pre-determined account for safe keeping. When, in these embodiments, the closing 520 takes place, the goods are shipped or documents are signed or services are completed 522.

Next, in certain embodiments, the funding 524 takes place. Digital payments are created automatically and made payable to payees specified in the terms and conditions above. Payments are approved to be released by the appropriate parties which may include: the payor, the escrow agent, a lender or bank, an insurance company or underwriter.

In exemplary implementations, the payment is then automatically reconciled 526 with appropriate banks verifying that the transaction has occurred per specified terms and conditions. Audit reports 528 can then be automatically generated by the system and provided to appropriate parties.

The platform allows for complete collaboration of end-to-end payment processing between interested parties while maintaining privacy associated with sensitive data. A user defined alert system automatically notifies users of potential problems and time sensitive information. Each task, change or update is automatically date and time logged creating a complete audit trail.

Although the transaction system clearly relates to transparent transactions, one of skill in the art would realize that there are many other possible applications for other kinds of transactions, such as securities exchanges, commodity trading, bond transactions, and the like. Amongst other applications, the process will perform as a clearing house for escrowing funds and data, function as a settlement and reconciliation agent for completing transactions, serve as a repository for reporting various types of information to the appropriate parties based on a need and right to know for multiple industries to including but not limited to the following: the medical industry (i.e., insurance companies, hospitals, clinics, doctors, pharmacies, specialized testing companies, etc.) for the entire “process;” U.C.C. (i.e., Uniform Commercial Code procedures) searches, filings, verifications, and payments for the entire process; providing escrow services for various types transactions that require 3^{rd} party settlement procedures; managing and mitigating the fiduciary payment facilitation process for Insurance claims and payments; managing and facilitating the various processes for Account Payable and Accounts Receivable departments for companies (i.e., manufacturers, distributors, vendors, retailers, etc.), amongst others.

I claim:

1. A system for performing automated reconciliation in financial transactions, comprising:
a. a server, further comprising multiple portals;
b. at least two transactors having access to the server by way of the portals, further comprising a payor and a payee;
c. a computer-readable program code, further comprising:
i. program code configured to initiate financial transactions;
ii. program code configured to store financial transaction information in a database;
iii. program code configured to transmit financial transaction information to transactors;
iv. program code configured to receive financial transaction information from transactors; and
v. program code configured to reconcile financial transactions based on the financial information provided by transactors.

2. The system of claim 1, further comprising at least one additional transactor chosen from the group consisting of: payors, payees, mortgage lenders, title companies, real estate agents, real estate brokers, recorders, underwriters, lenders, venders, investors, loan originators, and title companies, wherein the additional transactor is also able to view and participate in the transaction.

3. The system of claim 1, further comprising providing a secure digital environment for the secure storage of financial transaction information.

4. The system of claim 3, wherein the secure financial transaction information is selected from the group consisting of digital signatures, supporting documentation, financial information, bank records, HUD forms, tax forms, personal identification information, bank account information, social security number information, investment account information, legal documents, insurance documents, mortgage information, lender information, background check information and credit check information.

5. The system of claim 1, further comprising an automated pre-reconciliation process.

6. The system of claim 1, further comprising an automated post-reconciliation process.

7. The system of claim 1, wherein the computer readable program code further comprises computer-readable code configured such that one transactor's capital is held in escrow until the other transactor performs their obligations under the contract, such that each transactor is able to view the steps of the financial transaction through the server.

8. A method for performing financial transactions, comprising:
a. collecting financial transaction information from at least two transactors, further comprising a payor and a payee;
b. providing transactor financial transaction information; and
c. providing a computer utilizing software that through a series of steps creates a unified invoice and payment, wherein the payor's payment and payee's invoice are created simultaneously, such that each party is able to view the financial information of the transaction through the software.

9. The method of claim 8, further comprising providing at least one additional transactor chosen from the group consisting of: mortgage lenders, title companies, real estate agents, real estate brokers, recorders, underwriters, lenders, venders, investors, loan originators, and title companies, wherein the additional party is also able to view and participate in the transaction.

10. The method of claim 8, further comprising providing a further comprising software configured to create a secure digital environment for the secure storage of financial transaction information.

11. The computer program product of claim 10, wherein the secure financial transaction information is selected from the group consisting of digital signatures, supporting documentation, financial information, bank records, HUD forms, tax forms, personal identification information, bank account information, social security number information, investment account information, legal documents, insurance documents, mortgage information, lender information, background check information and credit check information. The method of claim 8, further comprising automating pre-reconciliation.

12. The method of claim 8, further comprising automating post-reconciliation.

13. A method of claim 8, wherein one transactor's capital is transparently held in escrow until the other transactor performs their obligations under the contract, such that each transactor is able to view the steps of the transaction through the software.

14. A computer program product for providing a financial transaction to transactors, the program comprising:
a. a computer readable medium having computer readable program code embodied therewith, the computer readable program code further comprising:
i. computer readable program code configured to initiate financial transactions;
ii. computer readable program code configured to store financial transaction information in a database;
iii. computer readable program code configured to display financial transaction information to the transactors;
iv. computer readable program code configured to receive financial transaction information from the transactors; and
v. computer readable program code configured to reconcile financial transactions based on the financial information provided by transactors.

15. The computer program product of claim 14, wherein the transactors are chosen from the group consisting of: payors, payees, mortgage lenders, title companies, real estate agents, real estate brokers, recorders, underwriters, lenders, venders, investors, loan originators, and title companies.

16. The computer program product of claim 14, further comprising computer readable program code configured to create a secure digital environment for the secure storage of financial transaction information.

17. The computer program product of claim 16, wherein the secure financial transaction information is selected from the group consisting of digital signatures, supporting documentation, financial information, bank records, HUD forms, tax forms, personal identification information, bank account information, social security number information, investment account information, legal documents, insurance documents, mortgage information, lender information, background check information and credit check information.

18. The computer program product of claim 14, further comprising computer readable program code configured to create an automated pre-reconciliation process.

19. The computer program product of claim 14, further comprising computer readable program code configured to create an automated post-reconciliation process.

20. The computer program product of claim 14, wherein the computer readable program code further comprises computer-readable code configured such that one transactor's capital is held in escrow until the other transactor performs their obligations under the contract, such that each transactor is able to view the steps of the financial transaction through the server.
